(19) United States
(12) Patent Application Publication
(10) Pub. No.: US 2025/0247922 A1
(43) Pub. Date: Jul. 31, 2025

(54) APPARATUS FOR SELECTIVELY HEATING A MATERIAL INTEGRATED WITH DISCRETE CARBON NANOTUBES

(71) Applicant: Elect Nano, LLC, Mesa, AZ (US)

(72) Inventors: Steven Lowder, Mesa, AZ (US); Brandon Sweeney, Mesa, AZ (US); Aaron Morelos Gomez, Mesa, AZ (US); Brent Williams, Mesa, AZ (US); Thomas Achee, Mesa, AZ (US)

(21) Appl. No.: 19/040,853

(22) Filed: Jan. 29, 2025

Related U.S. Application Data
(60) Provisional application No. 63/627,010, filed on Jan. 30, 2024.

(51) Int. Cl. H05B 6/40; H05B 6/04; H05B 6/44

(52) U.S. Cl. CPC H05B 6/40; H05B 6/04; H05B 6/44; H05B 2206/022

(57) ABSTRACT

An apparatus and method directed to selectively heating a material integrated with engineered discrete carbon nanotubes integrated into the material. A magnetic field generator, such as an induction coil, is aligned with a frame or other hardware and an electromagnetic field is applied to heat material targets supported by a tray aligned with the frame, thus avoiding heating the frame or other hardware and reducing the time required to melt or fuse a material.

### BACKGROUND OF THE INVENTION

### 1. Field of the Invention

The present invention relates to carbon nanotubes, and more particularly to selectively heating a material such as solder, or other metals to be joined, integrated with functionalized discrete carbon nanotubes.

### 2. Background and Related Art

Carbon nanotubes (CNTs) may be used for a number of applications including, in some embodiments, energy storage devices (e.g. ultracapacitors, supercapacitors and batteries), field emitters, conductive films and wires, membrane filters, reinforcing agents in polymer composites, semiconductor substrates, device modelling, automotive parts, boat hulls, sporting goods, coatings, actuators, electromagnetic shields, and drug delivery.

Carbon nanotubes tend to clump together during the manufacturing process and clumped/bundled CNTs are extremely difficult to untangle. Untangled CNTs can produce much more uniform materials and are exponentially superior in performance than materials manufactured with clumped tubes.

Solder plays an important role in the electronics manufacturing industry. Traditional solder materials and techniques have been limited by issues such as poor mechanical strength, insufficient thermal conductivity, and incompatibility with advanced manufacturing processes like radio frequency (RF) heating or magnetic manipulation.

Metal interconnects similarly play an important role in ultra-fine pitch bonding of semiconductor dies. Traditional interconnects that use copper pillars are limited based on the purity, precision, and process required for direct copper bonding (DCB) or copper-to-copper pillar bonding. The solid state diffusion bonding step employed in thermal compression bonding (TCB) is limited based on the diffusion of copper atoms at the interface of the connection to be formed. The process is further constrained by the temperature and pressure limits that the substrate and surrounding semiconductor materials can endure, taking into account factors such as material strength, stiffness, interlaminar toughness, coefficient of thermal expansion (CTE), and the chemical and thermal resistance of all involved materials.

### BRIEF DESCRIPTION OF THE SEVERAL VIEWS OF THE DRAWINGS

The objects and features of the present invention will become more fully apparent from the following description, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 depicts a discrete carbon nanotube (CNT), in accordance with one or more embodiments of the present disclosure.

FIG. 2 depicts an exploded diagram of a solder bump with dCNTs that are activated by an inductor coil, in accordance with one or more embodiments.

FIG. 3 depicts a diagram of an RF heated die with an induction coil that generates a magnetic field that may heat elements such as solder on or between a die and a substrate.

FIG. 4 illustrates a method for heating solder integrated with discrete carbon nanotubes.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting.

While this disclosure generally references solder, solder alloys, or other metallic interconnect materials, the principles herein may be applied to any material infused with discrete carbon nanotubes. Indeed, any reference herein to “solder” or “solder alloy” may refer more generally to any material including any kind of electronic interconnect including welding, thermoset interconnect, conductive adhesives, heat cured interconnect materials, solder alloy, or any metal alloy used to interconnect electronic devices, as well as non-metal materials such as adhesives, coatings, plastics, etc.

Current solder and thermoset adhesive interconnect technologies have many issues including semiconductor packaging issues for MCM, 3D, FlipChip, SiP, etc., non-uniform heating that yields poor solder joints, components subjected to high temperatures (230+ degrees Celsius) on all sides, multiple times, restricting sensitive component designs, encapsulation failures, solder joint issues, and difficulty in reworking.

Self-heating interconnect materials may help solve these issues. In some embodiments, self-heating interconnect materials may include targeted heating for any current and future packaging technology, ultrafast closed-loop heating controls, and precision rework. Heat generated in every interconnect can be tuned for spatial uniformity. Excess heat bleed is limited based on heat generated by temperature rise of interconnect solder or adhesive.

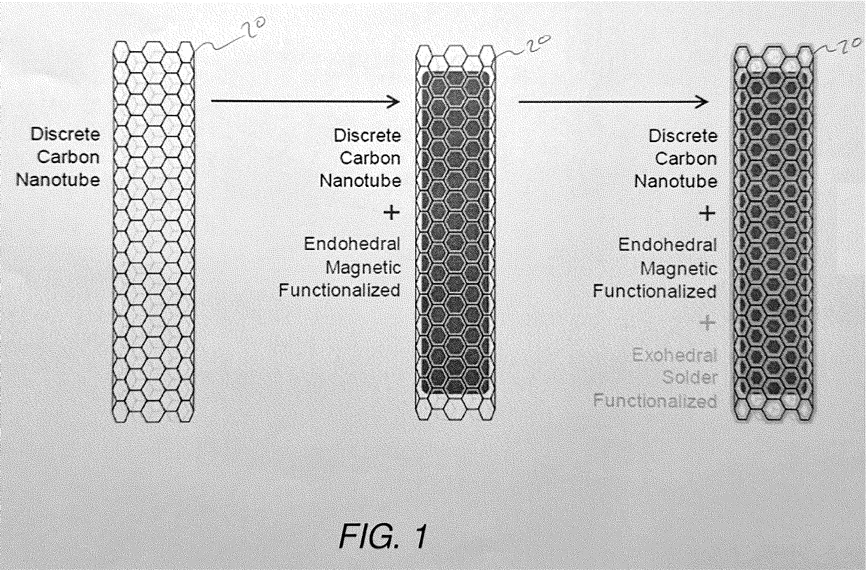

Referring now to FIG. 1, discrete CNTs (“dCNTs”) are typically strong radio frequency (RF) absorbers. High power RF electric fields can generate rapid, spatially selective, and material- localized heating. Thermoset adhesives can be cured in selective locations and heat is generated within the adhesive via joule heating of discrete CNTs.

Additionally, dCNT's may be chemically functionalized to include magnetic properties such as ferromagnetism, anti-ferromagnetism, ferrimagnetism, or superparamagnetism. These magnetic properties may be engineered to generate a large loss when subject to alternating magnetic fields, especially radio frequency magnetic fields. The loss, which is dissipated as heat, may be tuned for a specific magnetic field frequency by altering the composition or morphology of the magnetic functionalization. In some embodiments the dCNTs may absorb the alternating magnetic fields, causing the dCNTs to vibrate and generate heat. These same magnetic fields may be selected such that the frequency and field intensity do not substantially heat non-magnetic materials such as silicon, copper, epoxy, glass, and other common materials in a semiconductor computer chip.

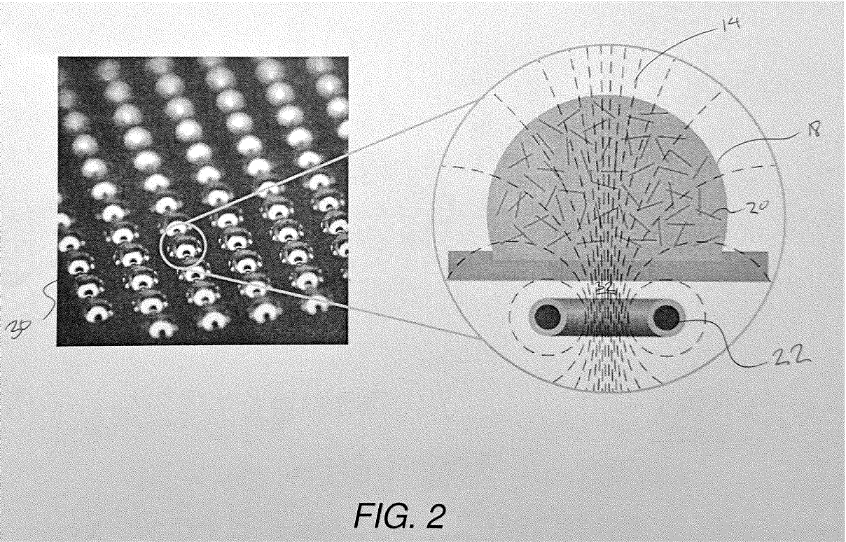

FIG. 2 illustrates magnetically-functionalized carbon nanotubes incorporated into solder alloys or metallic interconnects used to join semiconductor devices and assemblies. Thus the heat generated within the carbon nanotube would be selective and localized to that individual domain, such as a solder bump or pillars. Such selective heating of the functionalized carbon nanotubes may enable rapid formation of liquid solder or metal interconnects with minimal heat applied to the entire assembly. Anticipated benefits of targeted RF inductive heating, which facilitates precise, rapid, and localized heating of solder or metal interconnects, include reduced manufacturing costs through improved yield and reliability, enhanced performance of electronic devices by enabling finer pitch interconnects, and longer chip lifespans due to better thermal management during manufacturing.

In some embodiments, the heat generated by the functionalized carbon nanotubes may cause the solder or other material to melt. In other embodiments, the heat generated causes the material infused with the carbon nanotubes to fuse to another material via solid state diffusion (i.e., thermocompression bonding).

Some embodiments disclosed herein relate to semiconductor packaging and/or printed circuit board (PCB) assembly and soldering and heating or targeted heating for solder bumps or copper pillars on the semiconductor packaging and/or PCB assembly. In some embodiments, an array or matrix, (e.g., a tutte matrix) of micro-electromechanical systems (MEMS)-based induction coils is provided on a grid of pads on a surface of a substrate in a predetermined pattern. The pattern of an induction coil applicator may align with or mirror a pattern of solder bumps such that each bump is aligned with its own induction coil in a 1:1 ratio. In some embodiments one or more induction coils are configured to be selectively relocated relative to the PCB to align with one or more solder bumps or pillars. In some embodiments the relation is two-dimensional in the x,y plane. In some embodiments the relocation adjustment is three-dimensional in the x, y, z axis and configured to selectively position the induction coil to the desired position, distance and orientation. Each individual coil may receive its own address (e.g., x and y coordinates) by which the temperature profile of each bump may be controlled when heating up the solder bump on the chip. Nodes are provided that are configured to create an induction field to heat some specific and geographically adjacent bump or volume.

In addition to being configured to selectively determine the physical location of the coil, in some embodiments the energy of the magnetic field may be selectively increased or decreased. In some embodiments the amount of energy going to each individual coil may be modulated. In some embodiments the energy going to each individual coil may be attenuated or intensified relative to another location. In some embodiments the amount of energy going to each individual coil may be controlled and manipulated which may allow for targeted heating of corresponding solder bumps. In some embodiments, a distance between the chip and the array may be adjusted (e.g., by one or more microns) to place different bumps in the magnetic field. In some embodiments the chip is repositioned. In some embodiments the coil array is repositioned. In some embodiments the chip and the coil array are both repositioned.

As illustrated in FIG. 2, the amount of energy directed at each individual coil is modulated or adjusted by positioning a ferrite ring which can influence the power and direction of the magnetic fields. In some embodiments the ferrite ring serves as a ferrite lens close to the coil and magnetic field, such that the field is manipulated. Yet in another embodiment, the amount of energy at each coil is controlled through the use of different frequencies to activate (e.g., heat) different materials (e.g., metals or magnetic cores) inside the dCNTs integrated with the solder bump or metal interconnect. In some embodiments dCNTs are modified with a first substance with properties selected based on a response to a field generated at a first frequency and other dCNTs are modified with a second substance with properties selected based on a response to a field generated at a second frequency. In some embodiments a coil may be configured to emit the first frequency to activate the first set of dCNTs and emit the second frequency to activate the second set of dCNTs. In some embodiments a single dCNT may be modified with both a first substance and a second substance so that a single dCNT would respond to both the first frequency and the second frequency.

Besides an array of addressable coils (identifiable based the location in the array) used to apply a spatially controlled magnetic field, one may also use a single turn foil type applicator, multi-turn helical applicator, pancake coil, saddle coil, birdcage coil, Helmholtz coil, or topology- optimized freeform 3D coils designed to apply a shaped magnetic field to the semiconductor package or PCB assembly. These coil designs further benefit from ferrite flux control inserts which further shape, concentrate or otherwise manipulate the magnetic field to achieve the required field intensity for efficient heating and bonding of a chip interconnect. In some production environment embodiments, a single induction coil head or applicator geometry may utilize ferrite inserts or flux focusing “lenses” to optimize the heat generated in a specific device.

Referring further to FIG. 2, some embodiments include using susceptor materials such as ferrites, which are not “lossy” (i.e. energy is conserved). Similar materials may be used for a core of a transformer. In some embodiments an applicator apparatus may include a primary and a secondary coil, which may include a core that allows a magnetic field to be flipped and contain the magnetic field within the core. The core may get very hot which may be detrimental since energy is lost due to the heat. In some embodiments, a transformer may include ferrite composite materials or laminate iron core materials which are designed to transfer a magnetic field and contain it without losing energy due to heat such that the same material can be effectively shaped into a lens for the magnetic field. The material may be placed in or around the electrical coil which created the magnetic field, and magnetic field lines may be channeled or shaped in a specific area such that the field may be targeted to focus on specific layers or areas within a computer chip. The magnetic field can then be effectively moved in or out of the plane of focus. Accordingly, specific areas of the computer chip including specific solder bumps may be targeted by using the “lens” techniques discussed herein, thus avoiding loss of energy due to heat, as well as avoiding interfering with other areas of the computer chip that may be affected by heat or energy, including magnetic energy.

Some embodiments may comprise a coil which can be manipulated like a secondary plane of ferrite that is configured to move up and down (e.g., along the z-axis) in order to change the focus plane of the magnetic field. In other embodiments, the entire applicator (e.g., array) may be moved up or down to manipulate the location of the chip in relation to the applicator such that the focal point area of the magnetic field is focused on a desired location of the chip. In some cases, the applicator may be moved a number of microns in distance, which may be equal or similar to the height of one or more solder bumps. In some cases, a servo motor may be used to move the applicator or the chip in relation to the other.

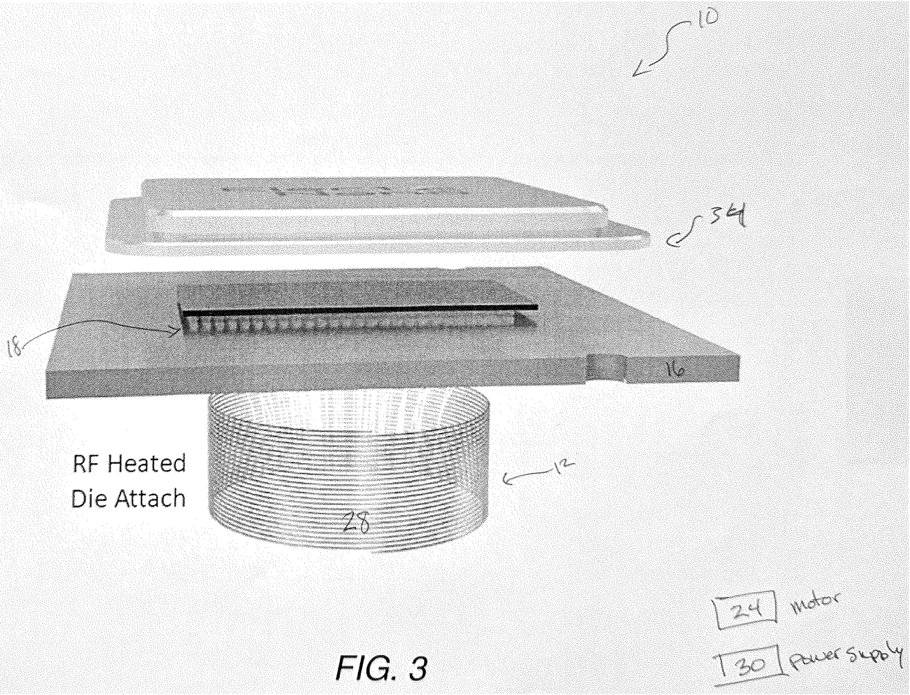

Referring now to FIGS. 2 and 3, an apparatus, system and method for selectively heating solder integrated with discrete carbon nanotubes. In some embodiments. One general aspect includes an apparatus for selectively heating solder integrated with discrete carbon nanotubes. In some embodiments the apparatus also includes a frame 10; a generator 12 aligned within the frame where the generator is configured to generate a magnetic field 14, a tray 16 aligned within the frame where the tray is disposed proximate the generator 12 where the tray 16 is configured to support at least one solder target 18 integrated with discrete carbon nanotubes 20, and a magnetic field lens 22 aligned within the frame 10 where the lens is disposed between the generator 12 and the tray 16 where the lens 22 is configured to manipulate the magnetic field. In some embodiments the frame comprises a workstation wherein the elements necessary to selectively heat solder integrated with discrete CNTs are aligned. In some embodiments the apparatus claimed herein is a single machine due to the high tolerances and micrometer spacings involved with soldering computer chips, CPBs and related technology. In some embodiments the apparatus claimed herein are structurally separate machines, such as on an assembly line, configured to position the elements in alignment to melt the solder integrated with the dCNTs.

In some embodiments the generator 10 comprises a coil configured to generate flux. In some embodiments the generator 10 is an induction coil 28 which generates an electromagnetic flux as current passes through the coil 28. In some embodiments the current is selectively modulated to produce a desired amplitude. In some embodiments the current is selectively modulated to produce a desired frequency.

Implementations may include one or more of the following features. In some embodiments the apparatus may include at least one motor 24, such as a servo motor for precision movements. In some embodiments the motor(s) 24 are configured to reposition at least one of the generator 12, the tray 16, and the magnetic field lens 2. In some embodiments the at least one motor 24 is configured to reposition at least one of the generator 12, the tray 16, and the magnetic field lens 22 in two dimensions. In some embodiments the at least one motor 24 is configured to reposition of at least one of the generator 12, the tray 16, and the magnetic field lens 22 in three dimensions. In some embodiments the distance between the generator 12, 28 is adjusted to optimize the intersection of the magnetic field and the target solder bump 18. Different positions in a stronger magnetic field have different strengths, thus the rate of heating in the target solder doped with the dCNTs will depend in part on the position of the target solder in the magnetic field.

In some embodiments the generator may include at least one induction coil 28. In some embodiments a power supply is configured to provide power to the at least one induction coil 28 at a plurality of frequencies. In some embodiments where the dCNTs are functionalized with chemistry that activates both at a first frequency and a second frequency (or third etc.), producing multiple frequencies (2 or more) will improve the ability to selectively activate different solder targets and thus control the heating produced by the solder. In some embodiments a PCB may comprise multiple solder targets which, if all were heated simultaneously, could adversely impact the silicon.

An apparatus that can selectively heat different solder contacts at different rates is an improvement. In some embodiments the generator may include a plurality of induction coils 28. In some embodiments a first induction coil 28 is configured to generate a first magnetic field 24 at a first frequency and where a second induction coil concentric the first induction coil 28 is configured to generate a second magnetic field at a second frequency. In some embodiments coils are nested. In some embodiments coils are concentrically aligned.

In some embodiments the plurality of induction coils 28 are arranged in an array corresponding to a predetermined array of target locations 30. In some embodiments the plurality of induction coils 28 may include an array of induction coils. In some embodiments the array comprises an induction coil in all potential locations for a PCB, such that the array of induction coils is packed as tight as physically possible. The PCB may then be designed to select solder sites that align with the array locations. In some embodiments the array would be programed to activate only the induction coils that are aligned with the targets. In some embodiments each induction coil in the array of induction coils is configured to selectively generate a magnetic field 14 independent of other induction coils in the array. In some embodiments the contacts are configured to at least partially melt when exposed to the magnetic field.

Implementations of the described techniques may include hardware, a method or process. Some embodiments include an apparatus for selectively heating solder integrated with discrete carbon nanotubes. In some embodiments the apparatus also includes a frame 10. In some embodiments the apparatus also includes a plurality of induction coils 28 aligned within the frame 10 where each induction coil 28 is configured to generate a magnetic field 14. Some embodiments comprise a tray 16 aligned within the frame 10 where the tray 16 is disposed adjacent the coils 28 and where the tray is configured to support a plurality of solder targets 18 comprising discrete carbon nanotubes 20 where the targets 18 are configured to at least partially melt when a magnetic field is applied. In some embodiments the apparatus also includes a plurality of magnetic field lenses 22 aligned within the frame 10 where the lenses 22 are disposed adjacent the tray 16 and each lens 22 is configured to focus 32 the magnetic field at the solder target.

Implementations may include one or more of the following features. In some embodiments the apparatus may include at least one motor 24 disposed within the frame 10 where the at least one motor 24 is configured to reposition of at least one of the induction coil 28, the tray 16, and the magnetic field lens 22. As discussed, in some embodiments The plurality of induction coils 22 may include an array of induction coils where each induction coil 28 in the array of induction coils is configured to selectively generate a magnetic field independent of other magnetic fields in the array. In some embodiments the frame 10 further may include a defined space in which at least one of the plurality of induction coils 28, the tray 16, the plurality of magnetic field lenses 22 is an independent structure.

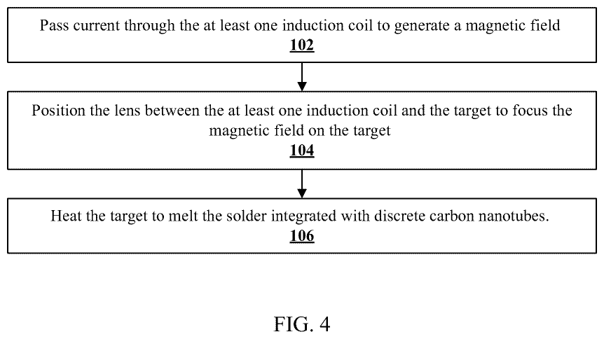

Referring now to FIG. 4, one general aspect includes a method for selectively heating solder integrated with discrete carbon nanotubes. In some embodiments the method comprises aligning at least one induction coil, at least one magnetic field lens, and at least one tray configured to support a target may include solder integrated with discrete carbon nanotubes 102; passing current through the at least one induction coil to generate a magnetic field, positioning the lens between the at least one induction coil and the target to focus the magnetic field on the target, 104 and heating the target to melt the solder integrated with discrete carbon nanotubes 106.

In some embodiments a ferrite winding may be used as a type of “lens” to manipulate and shape (e.g., focus) the magnetic field from the inside. The position of the ferrite in the coil may change the shape and intensity of the magnetic field, which may allow for targeted magnetism to excite and melt a particular solder alloy that has been infused with carbon nanotubes that are functionalized to be responsive to magnetism.

In some embodiments, frequencies may be adjusted to cause distortion in the magnetic field. In some embodiments, the frequency at which the applicator system is driven may be changed which may cause the field to change its peak intensity, which may allow for tuning, shaping, or focusing of the magnetic field. In some embodiments ferrite materials typically have a sharp response to a frequency range so if the frequency is changed, the power intensity of the magnetic field that is delivered may be tuned or altered, or in some cases, the shape itself of the magnetic field may be changed. In some embodiments, the magnetic field may be controlled and manipulated on the fly for a specific purpose.

The applicator system may include an addressable array of bumps 30. The applicator system may also include a stack of layers 34, where each layer may include MEMS-type assemblies. Each layer may also include loops that may be or include copper coils 28 or traces. Each addressable entry in the array may include a coil such that the address for each coil or bump may be targeted by the applicator which may activate (e.g., change frequency, focus magnetic field, move applicator to location, etc.) the solder bump at the indicated address. In some cases, pulse width modulation of the field may be used to adjust power driven. In some embodiments the temperature of the target points, such as a bump, an array of bumps or a pillar, an array of pillars or ‘Accordingly, in some embodiments, a temperature at a particular area of the array is monitored, and an adjustment is desired, or if a different response is detected in a center versus an edge of the array, or if one bump is larger than another, then it may be possible to know specifically which power should be used to control the temperature profile of the particular area in question. The temperature profile may be controlled in real time or based on a preprogrammed temperature ramp that is targeted for a specific package.

If certain materials are inserted within carbon nanotubes that are integrated with the solder, different frequencies may be determined to be effective to target different bumps at different temperatures. Additionally, using particular materials in the carbon nanotubes and using different frequencies and other methods disclosed herein, there is a high degree of control over the array of bumps and how they are manipulated and interacted with. An array may include several inductors at different depths, and the array may be shifted up and down or back and forth such that different bumps are targeted by different inductors. The array may be addressable by three axes (e.g., X, Y, Z) and any combination of each of the different methods for targeting specific bumps may be used to target the specific bumps, chip carriers, or chiplets. A stack of chips may be moved to take advantage of different types of equipment conveyors which can move in distinct and varied directions.

A challenge addressed by the present disclosure is aligning coils with bumps in the array. This is a challenge due to the small dimensions of the array. The inductance of each coil may be monitored such that when the coil is driven with a small signal, the electromagnetic response to the magnetic field generated by the coil may be measured which may be useful in determining how lossy the coil's field is, which may indicate whether the coil is properly aligned with the bump. Additionally, lossiness may contribute to a change in the inductance itself. This process may be useful as a kind of feedback loop, where when the alignment is very close, vibrations and responsiveness of the bump may be observed or measured and as the coil is moved, the inductance may be maximized when aligned properly. When inductance peaks and a maximum loss on the coil is registered, an accurate alignment has been achieved. In some embodiments, artificial intelligence (AI) may be used to help align the array with the inductor. Once the systems are aligned (e.g., in the X-Y plane, or in the X-Y-Z plane), re-flow may occur based on loss monitoring of the coil inductance. Inductance and the loss thereof may be called the quality factor (“Q factor”) of the circuit as there may be a maximum achieved for any types of inductors. In some embodiments, if a frequency is swept, a bell response may be expected when the system is perfectly aligned or coupled, and 100% is reached, but the highest possible matching factor occurs when the Q factor is maximized.

A coil may interact with a solder bump between a die and a substrate and heat up the bump as if it is being heated up from the inside. The solder bump may be integrated with CNTs that have been functionalized by endohedral functionalization or exohedral functionalization, as illustrated in FIG. 1. Regular solder (e.g., SAC305 solder alloy) does not react/respond to the induction from the coil or reacts/responds in a different way than the CNT-infused solder bump. In some embodiments, if induction from the coils as disclosed herein were to be applied to regular solder, no effect would be observed, while the same induction as applied to functionalized CNT-infused solder would be activated and flow. The same magnetic heating response applied to metallic interconnects such as copper pillars, where pure copper pillars would not appreciably heat in response to an alternating magnetic field, whereas copper pillars infused with magnetically functionalized CNTs would have a strong heating response to the same alternating magnetic field.

FIG. 1 depicts a discrete carbon nanotube, in accordance with one or more embodiments of the present disclosure. In some embodiments, the carbon nanotube in FIG. 1 is shown in three progressive configurations. The first configuration is a carbon nanotube that has been untangled and dispersed from a tangle of carbon nanotubes, which renders the carbon nanotube discrete and ready for functionalization. A group of discrete CNTs may enhance electrical conductivity and minimize electromigration as compared to clumped CNTs. Furthermore, discrete CNTs may function as a diffusion barrier between a magnetic core (e.g., of the second configuration shown in FIG. 1) and the solder matrix. Additionally, a discrete CNT may function as a template for a magnetic core to optimize induction heating.

The second configuration is a carbon nanotube that has gone through an endohedral functionalization process with ferromagnetic or superparamagnetic materials deposited within the CNT. Such a magnetic core may act as a susceptor to maximize a specific absorption rate (SAR) for a solder metal matrix composite. The magnetic core may also offset nanotube intrinsic density for buoyancy neutral nanotubes in solder. The third configuration is a CNT that has undergone an exohedral functionalization process which may improve surface properties of the CNT including adhesion, dispersion, wettability, etc.

FIG. 2 depicts a solder bump with CNTs that are activated by an inductor coil, in accordance with one or more embodiments. As shown in FIG. 2, there may be an array of solder bumps, where each solder bump may have integrated CNTs that are functionalized by endohedral functionalization or exohedral functionalization. The zoomed-in part of FIG. 2 depicts that a solder bump may be activated by an inductor coil which generates a magnetic field. The CNTs in FIG. 2 may include magnetic cores that are responsive to magnetic fields. Such cores may be activated (e.g., vibrate within the CNT) to generate localized heat while avoiding the surrounding bumps or areas of the chip are subjected to heat.

FIG. 3 depicts an RF heated die with an induction coil that generates a magnetic field that may heat elements such as solder on or between a die and a substrate.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed:

1. An apparatus for selectively heating a material integrated with discrete carbon nanotubes comprising:
a frame;
a generator aligned within the frame wherein the generator is configured to generate a magnetic field; and
a tray aligned within the frame wherein the tray is disposed proximate the generator wherein the tray is configured to support at least one material target integrated with discrete carbon nanotubes.

2. The apparatus of claim 1 further comprising at least one motor configured to reposition at least one of the generator, the tray, and the magnetic field lens.

3. The apparatus of claim 2 wherein the at least one motor is configured to reposition the at least one of the generator, the tray, and the magnetic field lens in two dimensions.

4. The apparatus of claim 2 wherein the at least one motor is configured to reposition the at least one of the generator, the tray, and the magnetic field lens in three dimensions.

5. The apparatus of claim 1 wherein the generator comprises at least one induction coil.

6. The apparatus of claim 1 wherein the generator comprises a plurality of induction coils.

7. The apparatus of claim 5 further comprising a power supply wherein the power supply is configured to provide power to the at least one induction coil at a plurality of frequencies.

8. The apparatus of claim 6 wherein a first induction coil is configured to generate a first magnetic field at a first frequency and wherein a second induction coil is configured to generate a second magnetic field at a second frequency.

9. The apparatus of claim 6 wherein the plurality of induction coils are arranged in an array corresponding to a predetermined array of target locations.

10. The apparatus of claim 1 further comprising a target comprising a plurality of contacts having a melting temperature greater than room temperature wherein the contacts are configured to at least partially melt when exposed to the magnetic field.

11. The apparatus of claim 6 wherein the plurality of induction coils comprise an array of induction coils wherein each induction coil in the array of induction coils is configured to selectively generate a magnetic field independent of other induction coils in the array.

12. The apparatus of claim 1, further comprising a magnetic field lens aligned within the frame wherein the lens is disposed between the generator and the tray wherein the lens is configured to manipulate the magnetic field.

13. An apparatus for selectively heating a material integrated with discrete carbon nanotubes comprising:
a frame;
a plurality of induction coils aligned within the frame wherein each induction coil is configured to generate a magnetic field; and
a tray aligned within the frame wherein the tray is disposed adjacent the induction coils and wherein the tray is configured to support a plurality of material targets comprising discrete carbon nanotubes wherein the targets are configured to be heated when influenced by an electromagnetic field.

14. The apparatus of claim 13 further comprising at least one motor disposed within the frame wherein the at least one motor is configured to reposition at least one of the induction coil, the tray, and the magnetic field lens.

15. The apparatus of claim 13 wherein the plurality of induction coils comprise an array of induction coils wherein each induction coil in the array of induction coils is configured to selectively generate a magnetic field independent of other magnetic fields in the array.

16. The apparatus of claim 13 wherein the frame further comprises a defined space wherein at least one of the plurality of induction coils, the tray, the plurality of magnetic field lenses is supported by an independent structure.

17. The apparatus of claim 13, further comprising a plurality of magnetic field lenses aligned within the frame wherein the lenses are disposed between the induction coils and the tray and each lens is configured to focus the magnetic field at the material target

18. A method for selectively heating a material integrated with discrete carbon nanotubes comprising:
aligning at least one induction coil, at least one magnetic field lens, and at least one tray configured to support a target comprising a material integrated with discrete carbon nanotubes;
passing current through the at least one induction coil to generate a magnetic field;
positioning the lens between the at least one induction coil and the target to focus the magnetic field on the target; and
heating the target comprising the material integrated with discrete carbon nanotubes.

19. The method of claim 16, wherein heating the target comprising the material integrated with discrete carbon nanotubes comprises melting the material.

20. The method of claim 16, wherein heating the target comprising the material integrated with discrete carbon nanotubes comprises fusing the material to another material via solid state diffusion.
